(19) United States
(12) Patent Application Publication
(10) Pub. No.: US 2008/0192782 A1
(43) Pub. Date: Aug. 14, 2008

(54) Dual Wavelength Laser Device, and System Comprising Same

(75) Inventor: Thierry Georges, Perros-Guirec (FR)

Correspondence Address: YOUNG & THOMPSON, 209 Madison Street, Suite 500, ALEXANDRIA, VA, 22314, US

(73) Assignee: OXXIUS, Lannion (FR)

(21) Appl. No.: 11/817,695

(22) PCT Filed: Mar. 3, 2006
(86) PCT No.: PCT/FR06/00478

§ 371 Date: Sep. 4, 2007

(30) Foreign Application Priority Data
Mar. 4, 2005 (FR) 05 02228

(51) Int. Cl. H01S 3/108; H01S 3/10; H01S 3/09

(52) U.S. Cl. 372/21

(57) ABSTRACT

The invention concerns a laser device (1, 13) comprising: a three-level amplifying medium (3) adapted to emit a first laser beam (3) of fundamental wavelength; a four-level amplifying medium (5) adapted to emit a second laser beam (7) of fundamental wavelength; a non-linear crystal (4) adapted to mix the first and second beams and to generate a third beam (14, 15) whereof the frequency is the sum of the frequencies of said first and second laser beams. Said device is characterized in that the three-level amplifying medium (3) and at least the non-linear crystal (4) form a resonant cavity for the first laser beam (6), and the four-level amplifying medium (5) and at least the non-linear crystal (4) form a resonant cavity for the second laser beam (7), the two amplifying media and the non-linear crystal forming a linear cavity.

This invention relates to a laser device having two wavelengths or two frequencies. It relates more particularly to the generation of a laser beam from a sum of two different frequencies.

In general, the wavelengths obtained by solid state lasers are fundamentally in the near infrared. In order to obtain wavelengths in the visible range, several techniques are possible including, in particular, that of the intracavity doubled laser. Such a laser comprises an gain medium (solid state laser based on a crystal doped with a rare earth) associated with a nonlinear crystal converting a near infrared fundamental signal emitted by the gain medium into a visible signal by doubling the frequency of the fundamental. However, certain wavelengths in the visible range do not correspondent to a doubling of frequency of a rare earth transition. Frequency doubling makes it possible to obtain, for example, a wave at 532 nm (1064 nm doubled, Nd:YAG or Nd:YVO₄), or for example at 514 nm (1029 nm doubled, Yb:YAG). Wavelengths not obtained by frequency doubling can however be approached by the sum of two frequencies. For, example, 488 nm can be approached by the sum of 1064 nm and 915 nm (two Nd:YV04 transitions) or by the sum of 1053 nm and 907 nm (two Nd/YLF transitions).

The principle of the frequency sum in potassium niobate KNbO₃ has already been described in a first article, “Efficient intracavity sum-frequency generation of 490 nm radiation by use of potassium niobate”, S. Shichijyo et al., Opt. Lett. 1.9, p. 1022 (1994). In this article, the continuous emission of a Ti:sapphire laser around 910 nm is mixed with the continuous emission at 1064 nm of an Nd:YVO₄ laser containing a crystal of potassium niobate. The, intracavity presence of the nonlinear crystal greatly increases the power at 1064 nm (16W for 400 mW of pumping). On the other hand, the emission of the Ti:sapphire laser is weak (typically 100 mW), which limits the power emitted at 490 nm.

A second article is also known: “All-solid-state continuous-wave doubly resonant all-intracavity sum-frequency mixer”, Hanno M. Kretshmann et al., Optics Letters Lett Vol 22, No 19, Oct. 1, 1997. The authors describe an arrangement for summing two frequencies in order to obtain a signal emitted in the red range around 620 nm. In order to do this, two four-level lasers having resonant frequencies of 1080 nm and 1444 nm respectively are used. A nonlinear medium is included In the resonant cavity of each four-level laser. A drawback of this device is therefore the use of two four-level lasers, which requires the use of two pumps, one pump for each four-level laser.

The document WO 02/103863 proposes mixing the emission of a three-level laser with that of a four-level laser, by optionally including a frequency doubler crystal inside the cavity of the four-level laser. The nonlinear crystal is explicitly removed from the cavity of the three-level laser. As in the first article, this arrangement has the drawback of mixing at least one low-power laser signal and therefore of greatly reducing the nonlinear conversion efficiency or requiring a high-efficiency nonlinear crystal, the latter generally being very costly. Furthermore, this arrangement is rather complex because it requires two pumps, two pump injections and the multiplexing of the pump of the four-level laser with the signal of the three-level laser.

The purpose of this invention is to overcome said drawbacks by proposing a new laser device that is simple to use and is inexpensive.

At least one of said objectives is achieved with a laser device comprising:
a three-level gain medium able to emit a first laser, beam of fundamental wavelength;
a four-level gain medium able to emit a second laser beam of fundamental wavelength;
a nonlinear crystal able to mix the first and second laser beams and to generate a third beam whose frequency is the sum of the frequencies of said first and second laser beams.

According to the invention, the three-level gain medium and at least the nonlinear crystal constitute a resonant cavity for the first laser beam, and the four-level gain medium and at least the nonlinear crystal constitute a resonant cavity for the second laser beam; the two gain media and the nonlinear crystal forming a linear cavity.

With the devise according to the invention, the two laser beams oscillate through the nonlinear crystal. The mixing takes place between two high power beams. Contrary to the system of the prior art, the nonlinear crystal can be of average efficiency, and therefore inexpensive.

With such a device according to the invention, two wavelengths originating from two different emission bands can oscillate simultaneously, because an exclusive gain region is provided for at least one of the two laser beams (or wavelength).

Preferably, the two gain media and the nonlinear crystal constitute a monolithic resonant linear cavity.

According to another aspect of the invention, there is proposed a system comprising a laser device such as described above and a pumping means constituted by a single laser diode. According to a first variant of the invention, the pumping means emits a laser beam which is able to excite both the three-level gain medium and the four-level gain medium. Thus, one part of the pump is absorbed by the three-level gain medium and the residue of the pump is absorbed by the four-level gain medium. This requires adjoining the two gain media, the cavity ending with the nonlinear crystal. In other words, the three-level gain medium and the nonlinear crystal are adjoined on two opposite faces respectively of the four-level gain medium. The output mirrors of the two lasers, i.e. the two gain media, three-level and four-level, are then situated on the output of the nonlinear crystal. Moreover, focussing the pump is optimized so that the four-level gain medium is pumped by the laser diode and by the three-level laser emission.

According to a second advantageous variant of the invention, the pumping means emits a laser beam which is able to excite only the three-level gain medium. This leaves free discretion as regards positioning the four-level gain medium. The latter is entirely pumped by the emission of the three-level laser. In order to do this, the three-level gain medium and the four-level gain medium are advantageously constituted by an identical rare earth and an identical crystal.

From the thermal point of view, the second variant is probably better than the previous one because the quantum defect for the four-level laser is lower. Moreover, the adaptation between the pump and the signal for the four-level laser is perfect. This also makes it possible to sandwich the crystal doubler and to carry out dielectric treatments only on the laser crystals, which correspond to an inexpensive treatment. In fact, in a preferred embodiment of the invention, the two gain media are respectively adjoined on two opposite faces of the nonlinear crystal, which is preferably a birefringent crystal.

According to an advantageous feature of the invention, the nonlinear crystal being inserted between the two gain media, the faces of the different elements of the device are treated such that:
the input of the three-level gain medium and the output of the four-level gain medium comprise a dielectric treatment that is reflective for said first laser beam;
the output of the three-level gain medium and the output of the four-level gain medium comprise a dielectric treatment that is reflective for said second laser beam;
the output of the three-level gain medium and the input of the four-level gain medium comprise a dielectric treatment that is transmitting for said first laser beam; and
the output of the four-level gain medium comprises a dielectric treatment that is transmitting for said third laser beam.

In other words, the two gain media and the nonlinear crystal constitute a resonant linear cavity for the first laser beam. The four-level gain medium and the nonlinear crystal constitute a resonant linear cavity for the second laser beam.

In general, the population inversion required for the oscillation of a three-level laser is-greater than that required for a four-level laser (as regards the reflection of comparable mirrors). When the oscillation of the four-level laser starts, the population inversion no longer increases, which does not allow the oscillation threshold of the three-level laser to be reached. In the second variant, the pump excites the exclusive gain medium of the three-level laser. The population inversion increases up to the threshold of the three-level laser. Beyond the threshold of this three-level laser, the second gain medium (four-level laser) begins to be excited by the partial absorption of the emission of the-three-level laser. The increase in the pump power then makes it possible to reach the threshold of the four-level laser.

Modellings have shown that beyond the threshold, the division of power between the three-level and four-level laser emissions follows the division of the three-level emission losses, out of and in the gain medium of the four-level laser. Thus, the two powers are equal when the absorption of the three-level laser emission in the amplifier of the four-level laser is equal to the other losses, i.e. the non-resonant losses and the losses by doubling. This is the situation that must be sought when it is desired to maximize the efficiency of the summing of the frequencies. Preferably, the four-level gain medium then exhibits absorption of the order of 1% at the wavelength of the three-level laser.

In each variant, two high-power laser beams are obtained because the nonlinear-crystal is inside the two laser cavities (resonant cavities for the first and second laser beams).

Another advantage of an arrangement according to the present invention, is the fact that the transverse modes of the gain media have a similar transverse size, which optimizes the conversion efficiency.

Other advantages and characteristics of the invention will become apparent on examination of the detailed description of an embodiment which is in no way limitative, and the attached diagrams, in which:

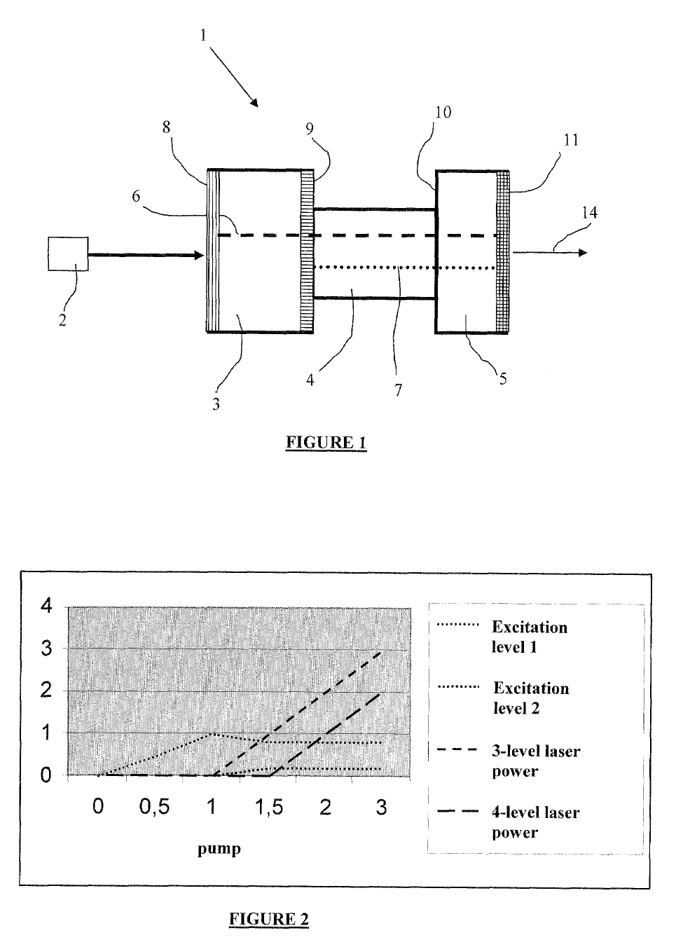

FIG. 1 shows a laser device forming a monolithic linear cavity according to the invention, the nonlinear, crystal being disposed between the two gain media;

FIG. 2 is a graph illustrating in a diagrammatic manner the development of the excitation and power levels of the two gain media of the device according to FIG. 1; and

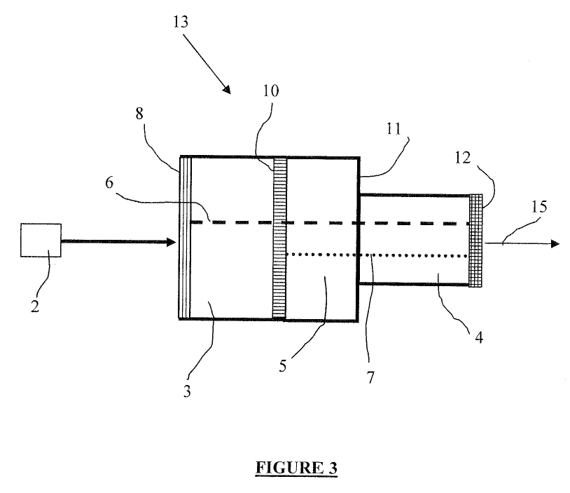

FIG. 3 shows a laser device according to this invention with the four-level gain medium arranged between the three-level gain medium and the nonlinear crystal.

In FIG. 1, there can be seen a laser device 1 according to the invention, forming a linear cavity. This laser device is pumped by a single laser diode 2. The laser beam emitted by the laser diode 2 is collinear with the device.

The loser device 1 is constituted by a nonlinear crystal 4 arranged in an adjoining manner between, at the input, a three-level gain medium 3 and, at the output, a four-level gain medium 5. The three-level gain medium 3 is a laser crystal emitting around 915 nm such as Nd:YVO₄ and receiving the beam emitted by the laser diode. The sole purpose of the laser beam emitted by the laser diode 2 is the excitation of this three-level gain medium 3. The nonlinear crystal is constituted by potassium niobate KNbO₃. The four-level gain medium 5 is a laser crystal emitting around 1064 nm such as Nd:YV0₄. The device 1 is designed to emit at its output 14 a 491 nm laser beam originating from the summing of the two laser beams of the two gain media,

The 915 nm cavity is closed by the HR915 dielectric treatments, i.e. reflecting at 915 nm, at the input 8 of the first gain crystal 3 and at the output 11 of the second gain crystal 5. In other words, the laser beam 6 at 915 nm is confined between the faces 8 and 11.

The 1064 nm cavity is closed by the HR1064 dielectric treatments, i.e. reflecting at 1064 nm, at the output 9 of the first gain crystal 3 and at the output 11 of the second gain crystal. In other words, the laser beam 7 at 1064 nm is confined between the faces 9 and 11.

The dielectric treatment at the output 9 of the first gain crystal 3 is of the HT915 type, i.e. transmitting at 915 nm. The dielectric treatment at the output 11 of the second gain crystal 5 is of the HT491 type in order to allow the output of the blue emission of the laser beam 14 at 491 nm.

Advantageously, with such an arrangement, each 915 nm and each 1064 nm cavity comprises the nonlinear crystal.

The table below shows the refraction indices determined in the KNbO₃ nonlinear doubler crystal of the device 1 according to the invention, at 303 K for the wavelengths 915 nm, 1064 nm and 491.7 nm:

| | a | b | c |
|---|---|---|---|
| 915 nm | 2.2712 | 2.2316 | 2.1295 |
| 1064 nm | 2.2572 | 2.2196 | 2.1198 |
| 491.7 nm | 2.4145 | 2.3500 | 2.2256 |

It is observed that: nₐ(915)+nₐ(1064)=2n_{c}(491.7), which corresponds to a type I non-critical phase matching.

The device 1 uses Nd:YVO₄ with an emission at 915 nm in the three-level, laser, and an emission at 1064 nm in the four-level laser. It is also possible to use Nd:GdVO₄ with an emission at 912 nm in the three-level laser and an emission at 1062.6 nm in the four-level laser.

FIG. 2, shows the development of the excitation and power levels of the two gain media 3 and 5. The horizontal axis shows the pump power in arbitrary units and the vertical axis shows the concentration of excited ions as well as the laser power in arbitrary units. The pump 2 exclusively excites (excitation level 1) the three-level gain medium 3. When the oscillations threshold of the latter is reached (1 on the horizontal axis in FIG. 2), the emitted laser power makes it possible to excite (excitation level 2) the four-level gain medium 5. The latter then, in its turn, emits a laser power when its oscillation threshold Is reached (1.5 on the horizontal axis).

FIG. 3 shows a variant 13 of the device according to this invention. The two gain media 3 and 5 are directly adjoined to each other. The nonlinear crystal 4 is adjoined to the four-level gain medium 5 such that the emissions of the three-level and four-level lasers are superimposed. The device 13 emits laser beam 15 at the output of the nonlinear crystal.

In this case, the 915 nm cavity is closed by the HR.915 dielectric treatments, i.e. reflecting at 915 nm, at the input 8 of the first gain crystal 3 and at the output 12 of the nonlinear crystal 4. In other words, the laser beam 6 at 915 nm is confined between the faces 8 and 12.

The 1064 nm cavity is closed by the HR.1064 dielectric treatments, i.e. reflecting at 1064 nm, at the input 10 of the second gain crystal 5 ad at the output 12 of the nonlinear crystal 4. In other words, the laser beam 7 at 1064 nm is confined between the faces 10 and 12.

Of course, the invention is not limited to the examples which have just been described and numerous adjustments can be made to these examples without exceeding the scope of the invention.

1. Laser device comprising:
a three-level gain medium (3) able to emit a first laser beam (6) of fundamental wavelength;
a four-level gain medium (5) able to emit a second laser beam (7) of fundamental wavelength;
a nonlinear crystal (4) able to mix the first and second laser beams and to generate a third beam (14) the frequency of which is the sum of the frequencies of said first and second laser beams.
characterized in that the three-level gain medium (3) and at least the nonlinear crystal (4) constitute a resonant cavity for the first laser beam (6), and the four-level gain medium (5) and at least the nonlinear crystal (4) constitute a resonant cavity for the second laser beam (7); the two gain media and the nonlinear crystal forming a linear cavity.

2. Device according to claim 1, characterized in that the two gain media and the nonlinear crystal constituent a monolithic resonant linear cavity.

3. Device (1) according to claim 1, characterized in that the two gain media are adjoined respectively on two opposite faces of the nonlinear crystal.

4. Device according to claim 3, characterized in that the four-level gain medium exhibits an absorption of the order of 1% at the wavelength of the three-level laser.

5. Device according to claim 3, characterized in that:
the input (8) of the three-level gain medium (3) and the output (11) of the four-level gain medium (5) comprise a reflecting dielectric treatment for said first laser beam (6);
the output (9) of the three-level gain medium (3) and the output (11) of the four-level gain medium (5) comprise a reflecting dielectric treatment for said second laser beam (7);
he output (9) of the three-level gain medium (3) and the input (10) of the four-level gain medium (5) comprise a transmitting dielectric treatment for said first laser beam (6); and
the output (11) of the four-level gain medium (5) comprises a transmitting dielectric treatment for said third beam (14).

6. Device (13) according to claim 1, characterized in that the three-level gain medium and the nonlinear crystal are respectively adjoined on two opposite faces of the four-level gain medium.

7. Device according to claim 1, characterized in that the three-level gain medium and the four-level gain medium are constituted by an identical rare earth are and an identical crystal.

8. System comprising a laser device according to claim 1, characterized in that it moreover comprises a pumping means constituted by a single laser diode (2).

9. System according to claim 8, characterized in that, the two gain media being adjoined to two opposite faces respectively of the nonlinear crystal, the pumping means emits a laser beam able to excite only the three-level gain medium (3).

10. System according to claim 8, characterized in that, the three-level gain medium and the nonlinear crystal being adjoined on two opposite faces respectively of the four-level gain medium, the pumping means emits a laser beam able to excite the three-level gain medium (3) and the four-level gain medium (5).

11. Device (1) according to claim 2, characterized in that the two gain media are adjoined respectively on two opposite faces of the nonlinear crystal.

12. Device according to claim 4, characterized in that:
the input (8) of the three-level gain medium (3) and the output (11) of the four-level gain medium (5) comprise a reflecting dielectric treatment for said first laser beam (6);
the output (9) of the three-level gain medium (3) and the output (11) of the four-level gain medium (5) comprise a reflecting dielectric treatment for said second laser beam (7);
he output (9) of the three-level gain medium (3) and the input (10) of the four-level gain medium (5) comprise a transmitting dielectric treatment for said first laser beam (6); and
the output (11) of the four-level gain medium (5) comprises a transmitting dielectric treatment for said third beam (14).

13. Device (13) according to claim 2, characterized in that the three-level gain medium and the nonlinear crystal are respectively adjoined on two opposite faces of the four-level gain medium.

14. Device according to claim 2, characterized in that the three-level gain medium and the four-level gain medium are constituted by an identical rare earth are and an identical crystal.

15. Device according to claim 3, characterized in that the three-level gain medium and the four-level gain medium are constituted by an identical rare earth are and an identical crystal.

16. Device according to claim 4, characterized in that the three-level gain medium and the four-level gain medium are constituted by an identical rare earth are and an identical crystal.

17. Device according to claim 5, characterized in that the three-level gain medium and the four-level gain medium are constituted by an identical rare earth are and an identical crystal.

18. Device according to claim 6, characterized in that the three-level gain medium and the four-level gain medium are constituted by an identical rare earth are and an identical crystal.

19. System comprising a laser device according to claim 2, characterized in that it moreover comprises a pumping means constituted by a single laser diode (2).

20. System comprising a laser device according to claim 3, characterized in that it moreover comprises a pumping means constituted by a single laser diode (2).
